(19) United States
(12) Patent Application Publication
(10) Pub. No.: US 2013/0166865 A1
(43) Pub. Date: Jun. 27, 2013

(54) Systems and Methods for Managing Parallel Access to Multiple Storage Systems

(71) Applicants: Alex Lemberg, Netanya (IL); Yaron Bar, Moshav Tzofit (IL)

(72) Inventors: Alex Lemberg, Netanya (IL); Yaron Bar, Moshav Tzofit (IL)

(21) Appl. No.: 13/335,217

(22) Filed: Dec. 22, 2011

(51) Int. Cl. G06F 12/16

(52) U.S. Cl. 711/162; 711/E12.103

(57) ABSTRACT

Systems and methods for managing parallel access to multiple storage systems are disclosed. In one implementation, a host system operatively coupled to at least a first memory system and a second memory system separates a file into a plurality of data chunks. The host system stores a first copy of the plurality of data chunks in the first memory and stores a second copy of the plurality of data chunks in the second memory. The host reads a data chunk of the plurality of data chunks of the file from the first memory system or the second memory system based on a determination of whether the first memory system or the second memory system is able to provide the data chunk to the host system more quickly. The host system may then assemble the data of the file based on the data chunk.

### BACKGROUND

Computing systems such as servers, personal computers, tablets, and cellular telephones often utilize a host system that communicates with one or more nonvolatile storage systems. An important feature by which storage systems are often judged is a speed at which a host system is able to write data to, and read data from, the storage system. Improved storage systems are desirable that are able to provide a host system the ability to write data to storage systems, and read data from storage systems, at increased speeds.

### SUMMARY

The present disclosure is directed to systems and methods for managing parallel access to multiple storage systems. In one aspect, a method is disclosed for managing parallel access to multiple storage systems. The method is performed in a host operatively coupled to at least a first memory system and a second memory system. A controller separates data of a file into a plurality of data chunks. The controller stores a first copy of the plurality of data chunks in the first memory system and stores a second copy of the plurality of data chunks in the second memory system. The controller reads a data chunk of the plurality of data chunks of the file from the first memory system or the second memory system based on a determination of whether the first memory system or the second memory system is able to provide the data chunk to the host system more quickly. The controller may then assemble the data of the file based on the data chunk.

In another aspect, a host system including an interface and a processor is disclosed. The interface is operatively coupled with at least a first memory system and a second memory system. The processor is in communication with the first memory system and the second memory system via the interface. The processor is configured to separate data of a file into a plurality of data chunks. The process is further configured to store a first copy of the plurality of data chunks in the first memory system and store a second copy of the plurality of data chunks in the second memory system. The processor is further configured to read a data chunk of the plurality of data chunks of the file from the first memory system or the second memory system based on a determination of whether the first memory system or the second memory system is able to provide the data chunk to the host system more quickly. The processor may then assemble the data of the file based on the data chunk.

### BRIEF DESCRIPTION OF THE DRAWINGS

FIG. 1 illustrates a host system coupled with multiple memory storage systems that may implement the disclosed methods for managing parallel access to multiple storage systems.

FIG. 2 is an example block diagram of an example flash memory system controller for use in the multiple die non-volatile memory of FIG. 1.

FIG. 3 is an example one flash memory bank suitable as one of the non-volatile memory banks illustrated in FIG. 1.

FIG. 4 is a representative circuit diagram of a memory cell array that may be used in the memory bank of FIG. 3.

FIG. 5 illustrates an example physical memory organization of the memory bank of FIG. 3.

FIG. 6 shows an expanded view of a portion of the physical memory of FIG. 5.

FIG. 7 is a flow chart of one implementation of a method for managing parallel access to multiple storage systems.

FIG. 8 is a flow chart of one implementation of a method for updating one or more data chunks in a system utilizing multiple storage systems.

### DETAILED DESCRIPTION OF THE DRAWINGS

The present disclosure is directed to systems and methods for managing parallel access to multiple storage systems. As explained in more detail below, a host system utilizes at least two memory systems to perform parallel processing. During operation, the host system separates a file into a plurality of data chunks and stores a copy of the plurality of data chunks in each of the memory systems. When the host reads the file from the memory systems, the host system simultaneously reads data chunks of the file from the memory systems to increase performance speed.

In addition to increased performance speed, the disclosed methods and systems provide host systems the ability to perform separate operations with respect to each memory system. For example, a host may read data from one memory system for use in playing a video or music, while simultaneously downloading and storing data to another memory system. Further, the disclosed systems and methods provide advantages in that a controller on the host system may implement the disclosed parallel processing without the addition of hardware. While the disclosed systems and methods for managing parallel access to multiple storage systems may be used with many devices and memory storage systems, it should be appreciated that the disclosed systems and methods are especially advantageous for mobile devices such as cellular phones with an embedded flash memory and a removable memory card.

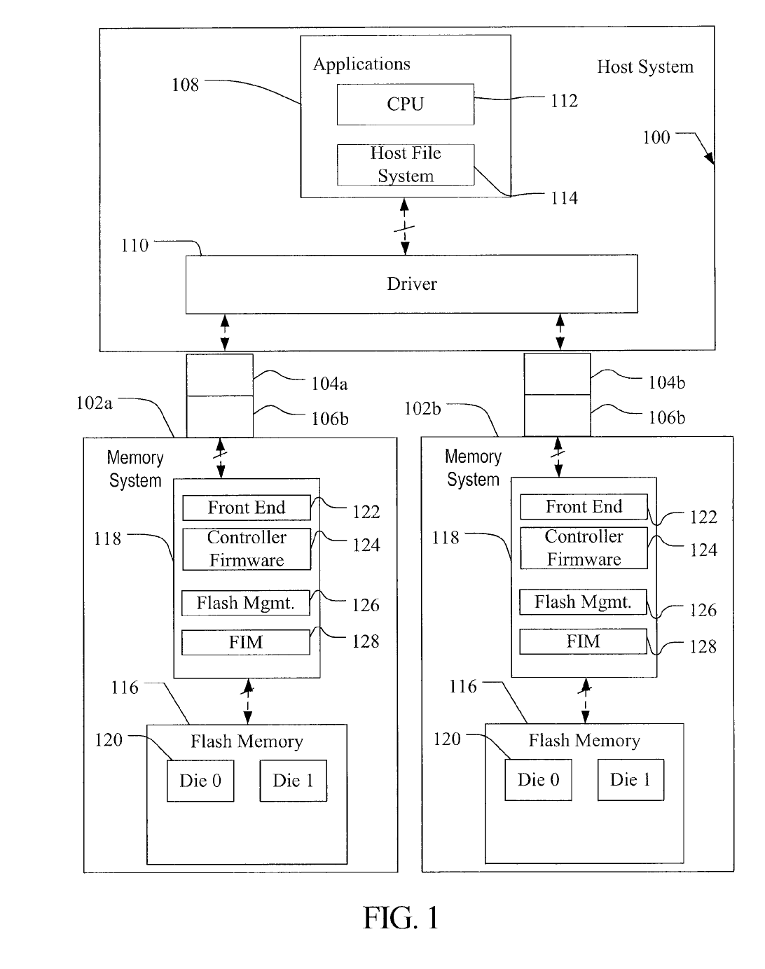

A memory system suitable for use in implementing aspects of the invention is shown in FIGS. 1-6. A host system 100 of FIG. 1 stores data into and retrieves data from a first memory system 102a and/or a second memory system 102b. The first and/or second memory systems 102a, 102b may be flash memory embedded within the host, such as in the form of a solid state disk (SSD) drive installed in a personal computer. Alternatively, the first and/or second memory systems 102a, 102b may be in the form of a card that is removably connected to the host through mating parts 104a and 106a, or 104b and 106b, of a mechanical and electrical connector as illustrated in FIG. 1. A flash memory configured for use as an internal or embedded SSD drive may look similar to the schematic of FIG. 1, with the primary difference being the location of the first and/or second memory systems 102a, 102b internal to the host. SSD drives may be in the form of discrete modules that are drop-in replacements for rotating magnetic disk drives.

The host system 100 of FIG. 1 may be viewed as having two major parts, in so far as the memory systems 102a, 102b are concerned, made up of a combination of circuitry and software. They are an applications portion 108 and a driver portion 110 that interfaces with the memory systems 102a, 102b. In a PC, for example, the applications portion 108 can include a processor 112 running word processing, graphics, control or other popular application software, as well as the file system 114 for managing data on the host 100. In a camera, cellular telephone or other host system that is primarily dedicated to perform a single set of functions, the applications portion 108 includes the software that operates the camera to take and store pictures, the cellular telephone to make and receive calls, and the like.

Either of the memory systems 102a, 102b of FIG. 1 may include non-volatile memory, such as flash memory 116, and a system controller 118 that both interfaces with the host 100 to which the memory system 102 is connected for passing data back and forth and controls the memory 116. The system controller 118 may convert between logical addresses of data used by the host 100 and physical addresses of the flash memory 116 during data programming and reading. The flash memory 116 may include any number of memory die 120 and two memory die are shown in FIG. 1 simply by way of illustration. Functionally, the system controller 118 may include a front end 122 that interfaces with the host system, controller logic 124 for coordinating operation of the memory 116, flash management logic 126 for internal memory management operations such as garbage collection, and one or more flash interface modules (FIMs) 128 to provide a communication interface between the controller with the flash memory 116.

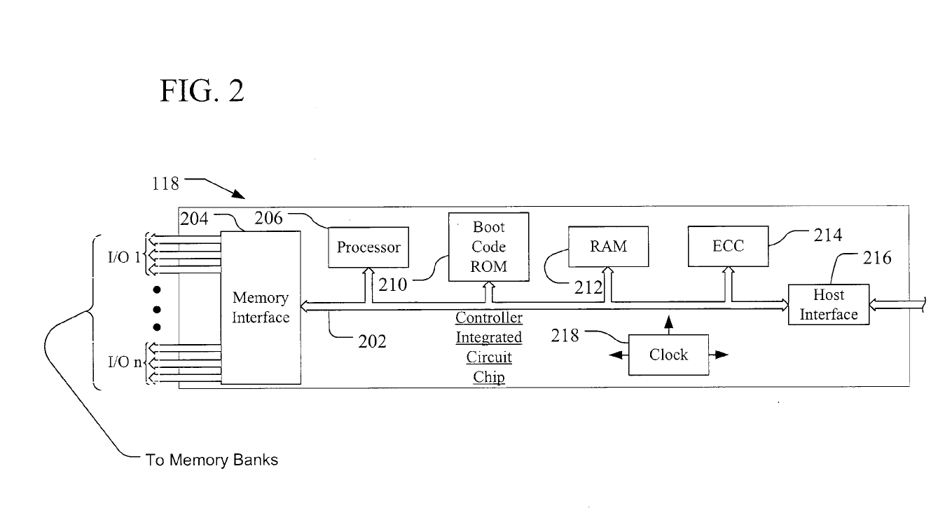

The system controller 118 may be implemented on a single integrated circuit chip, such as an application specific integrated circuit (ASIC) such as shown in FIG. 2. The processor 206 of the system controller 118 may be configured as a multi-thread processor capable of communicating separately with each of the respective memory banks 120 via a memory interface 204 having I/O ports for each of the respective banks 120 in the flash memory 116. The system controller 118 may include an internal clock 218. The processor 206 communicates with an error correction code (ECC) module 214, a RAM buffer 212, a host interface 216, and boot code ROM 210 via an internal data bus 202.

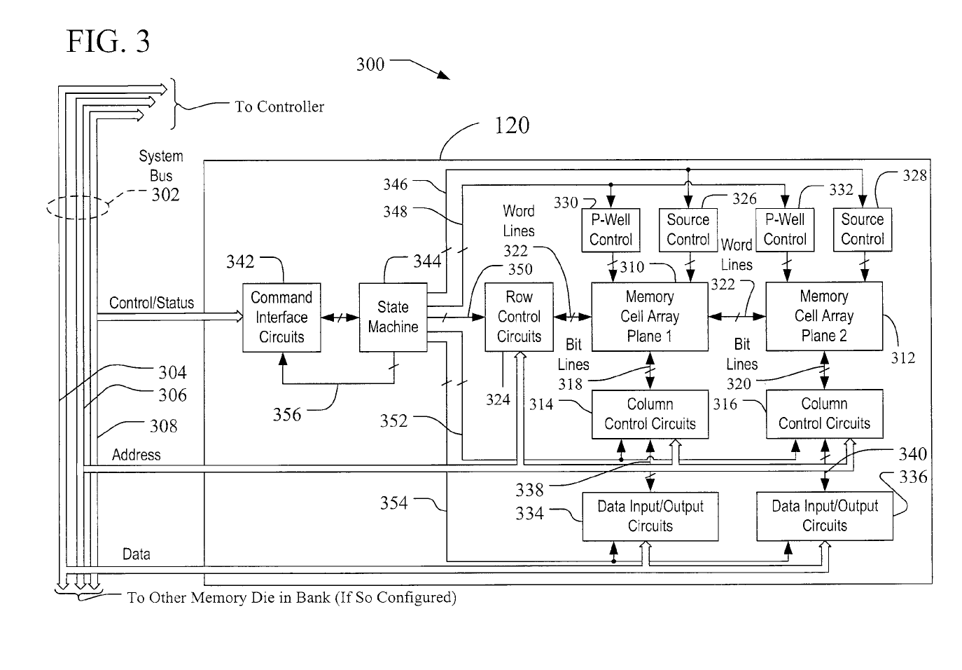

Each die 120 in the flash memory 116 may contain an array of memory cells organized into multiple planes. One of FIG. 3 shows such planes 310 and 312 for simplicity but a greater number of planes, such as four or eight planes, may instead be used. Alternatively, the memory cell array of a memory bank may not be divided into planes. When so divided, however, each plane has its own column control circuits 314 and 316 that are operable independently of each other. The circuits 314 and 316 receive addresses of their respective memory cell array from the address portion 306 of the system bus 302, and decode them to address a specific one or more of respective bit lines 318 and 320. The word lines 322 are addressed through row control circuits 324 in response to addresses received on the address bus 306. Source voltage control circuits 326 and 328 are also connected with the respective planes, as are p-well voltage control circuits 330 and 332. If the bank 300 is in the form of a memory chip with a single array of memory cells, and if two or more such chips exist in the system, data are transferred into and out of the planes 310 and 312 through respective data input/output circuits 334 and 336 that are connected with the data portion 304 of the system bus 302. The circuits 334 and 336 provide for both programming data into the memory cells and for reading data from the memory cells of their respective planes, through lines 338 and 340 connected to the planes through respective column control circuits 314 and 316.

Although the processor 206 in the system controller 118 controls the operation of the memory chips in each bank 120 to program data, read data, erase and attend to various housekeeping matters, each memory chip also contains some controlling circuitry that executes commands from the controller 118 to perform such functions. Interface circuits 342 are connected to the control and status portion 308 of the system bus 302. Commands from the controller 118 are provided to a state machine 344 that then provides specific control of other circuits in order to execute these commands. Control lines 346-354 connect the state machine 344 with these other circuits as shown in FIG. 3. Status information from the state machine 344 is communicated over lines 356 to the interface 342 for transmission to the controller 118 over the bus portion 308.

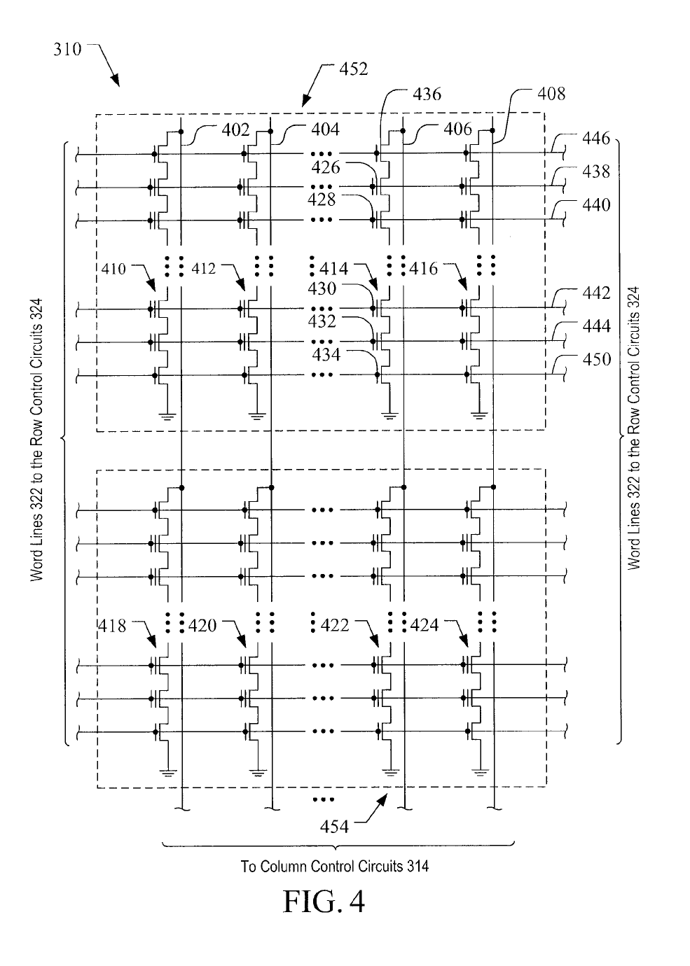

A NAND architecture of the memory cell arrays 310 and 312 is discussed below, although other architectures, such as NOR, can be used instead. An example NAND array is illustrated by the circuit diagram of FIG. 4, which is a portion of the memory cell array 310 of the memory bank 300 of FIG. 3. A large number of global bit lines are provided, only four such lines 402-408 being shown in FIG. 4 for simplicity of explanation. A number of series connected memory cell strings 410-424 are connected between one of these bit lines and a reference potential. Using the memory cell string 414 as representative, a plurality of charge storage memory cells 426-432 are connected in series with select transistors 434 and 436 at either end of the string. When the select transistors of a string are rendered conductive, the string is connected between its bit line and the reference potential. One memory cell within that string is then programmed or read at a time.

Word lines 438-444 of FIG. 4 individually extend across the charge storage element of one memory cell in each of a number of strings of memory cells, and gates 446 and 450 control the states of the select transistors at each end of the strings. The memory cell strings that share common word and control gate lines 438-450 are made to form a block 452 of memory cells that are erased together. This block of cells contains the minimum number of cells that are physically erasable at one time. One row of memory cells, those along one of the word lines 438-444, are programmed at a time. Typically, the rows of a NAND array are programmed in a prescribed order, in this case beginning with the row along the word line 444 closest to the end of the strings connected to ground or another common potential. The row of memory cells along the word line 442 is programmed next, and so on, throughout the block 452. The row along the word line 438 is programmed last.

A second block 454 is similar, its strings of memory cells being connected to the same global bit lines as the strings in the first block 452 but having a different set of word and control gate lines. The word and control gate lines are driven to their proper operating voltages by the row control circuits 324. If there is more than one plane in the system, such as planes 1 and 2 of FIG. 3, one memory architecture uses common word lines extending between them. There can alternatively be more than two planes that share common word lines. In other memory architectures, the word lines of individual planes are separately driven.

The memory cells may be operated to store two levels of charge so that a single bit of data is stored in each cell. This is typically referred to as a binary or single level cell (SLC) memory. Alternatively, the memory cells may be operated to store more than two detectable levels of charge in each charge storage element or region, thereby to store more than one bit of data in each. This latter configuration is referred to as multi level cell (MLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material.

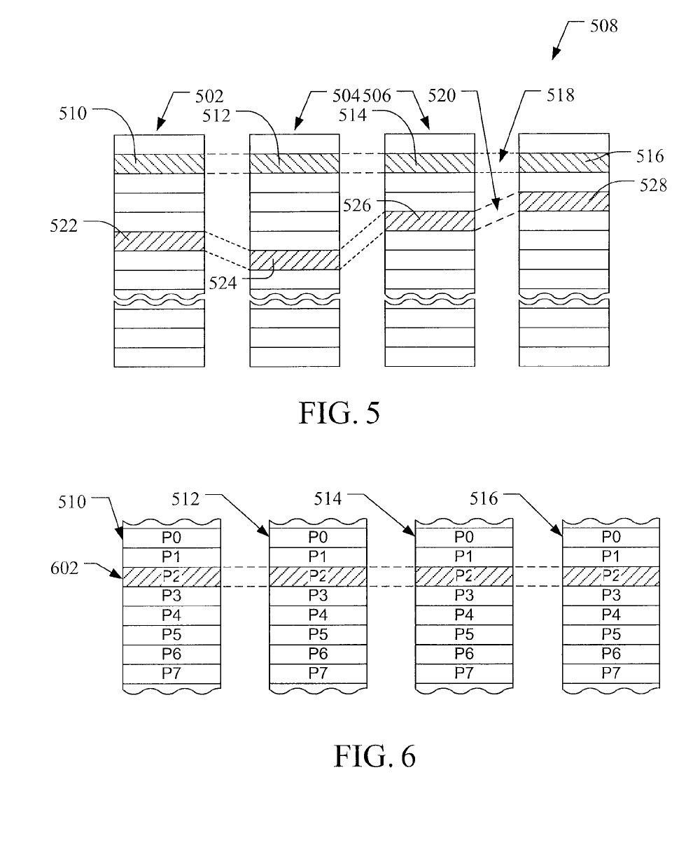

FIG. 5 conceptually illustrates a multiple plane arrangement showing four planes 502-508 of memory cells. These planes 502-508 may be on a single die, on two die (two of the planes on each die) or on four separate die. Of course, other numbers of planes, such as 1, 2, 8, 16 or more may exist in each die of a system. The planes are individually divided into blocks of memory cells shown in FIG. 5 by rectangles, such as blocks 510, 512, 514 and 516, located in respective planes 502-508. There can be dozens or hundreds of blocks in each plane.

As mentioned above, a block of memory cells is the unit of erase, the smallest number of memory cells that are physically erasable together. For increased parallelism, however, the blocks are operated in larger metablock units. One block from each plane is logically linked together to form a metablock. The four blocks 510-516 are shown to form one metablock 518. All of the cells within a metablock are typically erased together. The blocks used to form a metablock need not be restricted to the same relative locations within their respective planes, as is shown in a second metablock 520 made up of blocks 522-528. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

The individual blocks are in turn divided for operational purposes into pages of memory cells, as illustrated in FIG. 6. The memory cells of each of the blocks 510-516, for example, are each divided into eight pages P0-P7. Alternatively, there may be 32, 64 or more pages of memory cells within each block. The page is the unit of data programming and reading within a block, containing the minimum amount of data that are programmed or read at one time. In the NAND architecture of FIG. 3, a page is formed of memory cells along a word line within a block. However, in order to increase the memory system operational parallelism, such pages within two or more blocks may be logically linked into metapages. A metapage 602 is illustrated in FIG. 6, being formed of one physical page from each of the four blocks 510-516. The metapage 602, for example, includes the page P2 in each of the four blocks but the pages of a metapage need not necessarily have the same relative position within each of the blocks.

Referring again to FIG. 1, in order to implement parallel access to multiple storage devices, the processor 112 of the host system 100 operates as a management layer that interfaces between the host system 100 and the memory systems 102a, 102b. The management layer operating on the processor 112 of the host system 100 controls the storing of data to, and reading of data from, the first and second memory systems 102a, 102b. Because the management layer is operated on the processor 112 of the host system 100, the disclosed systems and methods may operate parallel access to multiple storage devices without the use of additional hardware components.

During operation, before the host system 100 stores a file in either of the memory systems 102a, 102b, the host system 100 breaks the file into a plurality of data chunks. The host system 100 stores a first copy of the plurality of data chunks of the file in the first memory system 102a and stores a second copy of the plurality of data chunks of the file in the second memory system 102b. When the host system 100 later reads the file from the first and second memory systems 102a, 102b, the host reads the file in data chunks from the first memory system 102a and/or the second memory system 102b based on factors such as which memory system is currently available to provide data to the host, and when both memory systems are available to provide data to the host, which memory system can provide a data chunk to the host more quickly.

The host system 100 receives the data chunks in parallel from the first and second memory systems 102a, 102b such the host system 100 may receive a first data chunk from the first memory system 102a while simultaneously receiving a second data chunk from the second memory system 102b. Because the host system 100 receives the plurality of data chunks from the first and second memory systems 102a, 102b in parallel, it will be appreciated that the host system 100 reads the file from the memory systems more quickly than if the host system 100 were to read all the data chunks that make up the file from the first memory system 102a or if the host system 100 were to read all the data chunks that make up the file from the second memory system 102b.

Additionally, storing a first copy of the plurality of data chunks of the file in the first memory system 102a and storing a second copy of the plurality of data chunks of the file in the second memory system 102b provides the host system 100 the ability to simultaneously perform two different functions with respect to the two memory systems. For example, the host system 100 may read data from the first memory system 102a while simultaneously writing data to the second memory system 102b. This provides the ability for the host system 100 to perform actions such as playing a video or music from data stored in the first memory system 102a while simultaneously downloading data to store in the second memory system 102b.

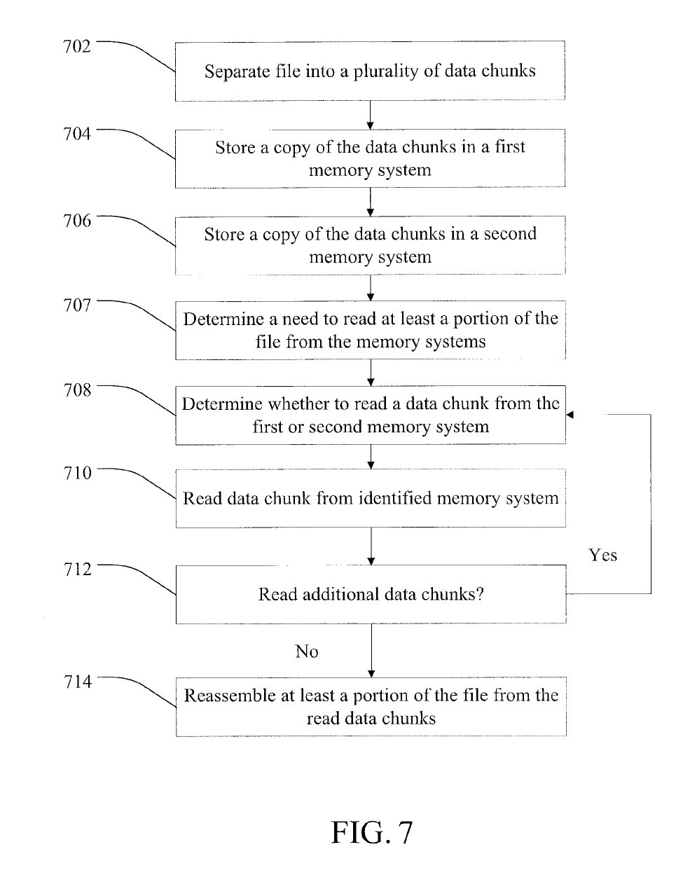

FIG. 7 is a flow chart of one implementation of a method for managing parallel access to multiple storage systems. The method begins at step 702 with a host device separating data of a file into a plurality of data chunks. The file may be any type of file that is capable of being separated into a plurality of data chunks. The host device may separate the data of the file into data chunks based on factors such as a size of a file and memory access performance.

At step 704, the host stores a first copy of the plurality of data chunks to a first memory system, and at step 706, the host stores a second copy of the plurality of data chunks to a second memory system. In some implementations, the host device may be a cellular telephone, the first memory system may be an embedded flash memory, and the second memory system may be a removable memory card. However, in other implementations, different devices and/or memory configurations may be used.

At step 707, the host determines a need to read at least a portion of the file from the memory systems. At step 708, the host determines whether to read a data chunk for the file from the first memory system or the second memory system. In some implementations, the host may determine whether to read the data chunk for the file from the first memory system or the second memory system based on factors such as which memory system will be available first to provide the data chunk; when both the memory systems are available, which memory system is able to provide the data chunk to the host more quickly; whether the first or second memory system is storing a more recent version of the chunk of data; and/or any other performance factor associated with the first memory system and/or the second memory system that may assist the host in determining which memory system to read the data chunk from in order to increase performance.

For example, when a host determines which memory system will be available first to provide a data chunk, the host may examine whether one of the memory systems is currently booting up, whether an application is currently using one of the memory systems, whether the host is currently reading data from, or writing data to, one of the memory systems, whether one of the memories can provide faster performance, and/or any other factor that may indicate to the host that one of the memory systems may be available to provide data to the host prior to another memory system. In some implementations, the host will decide to read the data chunk from the memory system that will be available to the host first unless one of the memory systems is storing a more recent version of the data chunk.

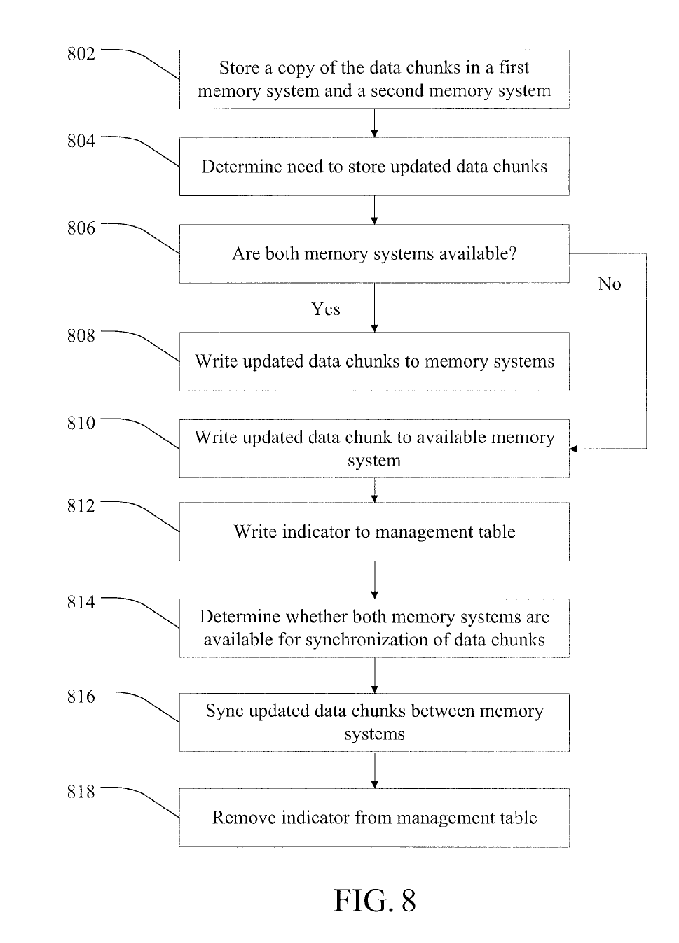

In some instances, as explained in more detail below in conjunction with FIG. 8, one of the memory systems may store a more recent version of the data chunk due to the host writing updated data to a memory system. To determine whether the first or second memory system is storing a more recent version of the data chunk, the host may look for an indicator stored in a management table associated with the first or second memory that indicates which specific data chunks stored in the memory system are a more recent version of the data chunk that than the counterpart data chunks stored in another memory system. When one of the memory systems is storing a data chunk that is a more recent version of the data chunk than the data chunk stored in another memory system, the host reads the data chunk from the memory system storing the most recent version of the data chunk.

At step 710, the host reads the data chunk from the identified memory system. At step 712, the host determines whether it needs to read additional data chunks from the memory systems to reassemble the required portion of the file. When the host determines that it does not need to read additional data chunks from the memory systems, at step 714, the host may reassemble at least a portion of the file from the data chunks read from the memory systems.

However, when the host determines it needs to read additional data chunks from the memory systems, the method loops to step 708 and the above-described method is repeated. The above-described method is repeated until the host determines at step 712 that it does not need to read additional data chunks from the memory systems, and at step 714, the host reassembles at least a portion of file from the data chunks read from the memory systems.

In the implementations described above, the first and second memory systems are described as being present in a system or device. However, when one of the memory systems is removable, such as when the first memory system is an embedded flash memory and the second memory system is a removable memory card, it will be appreciated that both memory systems may not always be present in a system. In order to account for this, the host may be configured to determine when each of the memory systems is present so that the host may perform parallel access to multiple storage devices when multiple storage device systems are present, and refrain from attempting to perform parallel access to multiple storage devices when multiple storage devices are not present in the system.

Further, while the methods described above are described with respect to two memory systems, it will be appreciated that similar methods may be implemented with a system comprising more than two memory systems. When employing more than two memory systems, each memory system would store a copy of the plurality of data chunks of a file such that when the host reads at least a portion of the file from the multiple memory systems, the host may simultaneously read a data chunk of the file from two or more of the memory systems.

As stated above, a host may periodically update one or more data chunks stored in the first memory system or the second memory system. FIG. 8 is a flow chart of one implementation of a method for updating one or more data chunks in a system or device utilizing multiple storage systems. At step 802, a host stores a first copy of a plurality of data chunks of a file in a first memory system and stores a second copy of a plurality of data chunks of the file in a second memory. At step 804, the host determines a need to store one or more updated data chunks of the file to the first memory and/or the second memory. At step 806, the host determines the availability of the first memory system and the second memory system. When both memory systems are available, the host writes the updated data chunks to both memory systems at step 808.

However, when the host determines at step 806 that only one of the memory systems is available, at step 810, the host writes the updated data chunks to the available memory system. At step 812, the host writes an indicator in a management table that indicates to the host that the updated data chunks stored in the memory system are a more recent version of the data chunks than the counterpart data chunks stored in other memory systems. For example, if the host determines that the first memory system is available, but the second memory systems is being utilized by another application, the host writes the updated data chunks to the first memory system. The host then writes an indicator to a management table associated with the first memory system that indicates that the updated data chunk in the first memory system is a more recent version of the data chunk than the counterpart data chunk stored in the second memory system.

At step 814, the host periodically determines whether the first and second memory systems are available to synchronize (“sync”) data between the memory systems. When the host determines that the first and second memory systems are available to sync data between the memory systems, at step 816, the host syncs the data chunks between the memory systems. At step 818, the host then removes any indicators that indicate data chunks in one of the memory systems are a more recent version of the data chunks than the counterpart data chunks stored in the other memory system.

When the host determines at step 814 that the first and second memory systems are not available to sync data between the memory systems, the host may continue to periodically check whether the first and second memory systems are available to sync data between the memory systems or loop to step 804 where the host determines a need to store one or more updated data chunks of the file to the first memory system and/or the second memory system. It will be appreciated that in some occurrences when there is a period of time when both memory systems are not available to sync the data between the two memory system, the first memory system may store some data chunks that are of a more recent version over the data chunks than the counterpart data chunks stored in the second memory, while the second memory system is simultaneously storing other data chunks that are of a more recent version of the data chunks than the counterpart data chunks stored in the first memory system.

While the implementations described above allow the host to store updated chunks of data in the first memory system or the second memory system depending on the availability of the first and second memory systems, in other implementations, the host may only stored updated chunks of data in one of the memory systems. For example, when the device is a cellular phone, the first memory system is an embedded flash memory, and the second memory system is a removable memory card, the host may only store updated chunks of data in the embedded flash memory.

FIGS. 1-8 teach systems and methods for managing parallel access to multiple storage systems. As explained above, a host system utilizes at least two memory systems to perform parallel processing. Generally, during operation the host system separates a file into a plurality of data chunks and stores a copy of the plurality of data chunks in each of the memory systems. When the host system reads the file from the memory systems, the host system simultaneously reads data chunks of the file from the memory systems. Performing parallel processing provides advantages such as increased system performance speed and the ability to perform separate operations with respect to each memory system.

Further the disclosed systems and methods provide a host system the ability to perform parallel processing without the addition of extra hardware. As discussed above, in order to implement parallel access to multiple storage devices, a processor of a host system may operate as a management layer that interfaces between the host system and the memory systems. The management layer operating on the processor of the host system controls the storing of data to, and reading of data from, the first and second memory systems. Because the management layer is operated on the processor of the host system, the disclosed systems and methods may operate parallel access to multiple storage devices without the use of additional hardware components.

It is intended that the foregoing detailed description be regarded as illustrative rather than limiting, and that it be understood that it is the following claims, including all equivalents, that are intended to define the spirit and scope of this invention.

1. A method for managing parallel access to multiple storage systems, the method comprising:
in a host system operatively coupled to at least a first memory system and a second memory system:
separating data of a file into a plurality of data chunks;
storing a first copy of the plurality of data chunks in the first memory system;
storing a second copy of the plurality of data chunks in the second memory system; and
reading a data chunk of the plurality of data chunks of the file from the first memory system or the second memory system based on a determination of whether the first memory system or the second memory system is able to provide the data chunk to the host system more quickly.

2. The method of claim 1, further comprising:
assembling the data of the file based on the data chunk.

3. The method of claim 1, further comprising:
storing one or more updated data chunks of the plurality of data chunks in the first memory system; and
storing in a management table associated with the first memory system an indication that the one or more updated data chunks stored in the first memory system are a more recent version of the data chunks than a counterpart one or more data chunks stored in the second memory system.

4. The method of claim 3, further comprising:
after storing the one or more updated data chunks in the first memory system, reading a second data chunk of the plurality of chunks from the first memory system or the second memory system based on whether an updated version of the data chunk is stored in the first memory system and based on a determination of whether the first memory system or the second memory system is able to provide the second data chunk to the host system more quickly.

5. The method of claim 3, further comprising:
synchronizing the data chunks of the plurality of data chunks stored in the second memory system with at least the one or more updated data chunks stored in the first memory system such that the plurality of data chunks stored in the first memory system and the plurality of data chunks stored in the second memory system are substantially the same; and
removing the indication from the management table associated with the first memory system that the one or more updated data chunks stored in the first memory system are a more recent version of the data chunks than the counterpart one or more data chunks stored in the second memory system.

6. The method of claim 1, further comprising:
storing one or more updated data chunks of the plurality of data chunks in the first memory system;
storing an indication in a management table associated with the first memory system that the one or more updated data chunks stored in the first memory system are a more recent version of the data chunks than a counterpart one or more data chunks stored in the second memory system;
storing one or more updated data chunks of the plurality of data chunks in the second memory system, wherein the one or more updated data chunks stored in the first memory system are different than the one or more updated data chunks stored in the second memory system; and
storing an indication in a management table associated with the second memory system that the one or more updated data chunks stored in the second memory system are a more recent version of the data chunks than a counterpart one or more data chunks stored in the first memory system.

7. The method of claim 6, further comprising:
after storing one or more updated data chunks in the first memory system and after storing one or more updated data chunks in the second memory system, reading a second data chunk of the plurality of chunks from one of the first memory system or the second memory system based on whether an updated version of the data chunk is stored in the first memory system or the second memory system and based on a determination of whether the first memory system or the second memory system is able to provide the second data chunk to the host system more quickly.

8. The method of claim 6, further comprising:
synchronizing one or more data chunks stored in the first memory system with one or more data chunks stored in the second memory system such that the plurality of data chunks stored in the first memory system and the plurality of data chunks stored in the second memory system are substantially the same;
removing the indication in the management table associated with the first memory system that one or more updated data chunks stored in the first memory system are a more recent version of the data chunks than the counterpart one or more data chunks stored in the second memory system; and
removing the indication in the management table associated with the second memory that one or more updated data chunks stored in the second memory system are a more recent version of the data chunks than the counterpart one or more data chunks stored in the first memory system.

9. The method of claim 1, wherein the first memory system is an embedded flash memory.

10. The method of claim 9, wherein the second memory system is a removable memory card.

11. A host system comprising:
an interface operatively coupled with at least a first memory system and a second memory system; and
a processor in communication with the first memory system and the second memory via the interface, the processor configured to:
separate data of a file into a plurality of data chunks;
store a first copy of the plurality of data chunks in the first memory system;
store a second copy of the plurality of data chunks in the second memory system; and
read a data chunk of the plurality of data chunks of the file from the first memory system or the second memory system based on a determination of whether the first memory system or the second memory system is able to provide the data chunk to the host system more quickly.

12. The host system of claim 1, wherein the processor is further configured to assemble the data of the file based on the data chunk.

13. The host system of claim 11, wherein the processor is further configured to:
store one or more updated data chunks of the plurality of data chunks in the first memory system; and
store in a management table associated with the first memory system an indication that one or more updated data chunks stored in the first memory system are a more recent version of the data chunks than a counterpart one or more data chunks stored in the second memory system.

14. The host system of claim 13, wherein the processor is further configured to:
after storing one or more updated data chunks in the first memory system, read a second data chunk of the plurality of data chunks from the first memory system or the second memory system based on whether an updated version of the data chunk is stored in the first memory system and based on a determination of whether the first memory system or the second memory system is able to provide the second data chunk to the host system more quickly.

15. The host system of claim 13, wherein the processor is further configured to:
synchronize the data chunks of the plurality of data chunks stored in the second memory system with at least the one or more updated data chunks stored in the first memory system such that the plurality of data chunks stored in the first memory system and the plurality of data chunks stored in the second memory system are substantially the same; and
remove the indication from the management table associated with the first memory system that the one or more updated data chunks stored in the first memory system are a more recent version of the data chunks than the counterpart one or more data chunks stored in the second memory system.

16. The host system of claim 11, wherein the processor is further configured to:
store one or more updated data chunks of the plurality of data chunks in the first memory system;
store an indication in a management table associated with the first memory system that the one or more updated data chunks stored in the first memory system are a more recent version of the data chunks than a counterpart one or more data chunks stored in the second memory system;
store one or more updated data chunks of the plurality of data chunks in the second memory system, wherein the one or more updated data chunks stored in the first memory system are different than the one or more updated data chunks stored in the second memory system; and
store an indication in a management table associated with the second memory system that the one or more updated data chunks stored in the second memory system are more recent than a counterpart one or more data chunks stored in the first memory system.

17. The host system of claim 16, wherein the processor is further configured to:
after storing one or more updated data chunks in the first memory system and after storing one or more updated data chunks in the second memory system, read a second data chunk of the plurality of chunks from the first memory system or the second memory system based on whether an updated version of the data chunk is stored in the first memory system or the second memory system and based on a determination of whether the first memory system or the second memory system is able to provide the second data chunk to the host system more quickly.

18. The host system of claim 16, wherein the processor is further configured to:
synchronize one or more data chunks stored in the first memory system with one or more data chunks stored in the second memory system such that the plurality of data chunks stored in the first memory system and the plurality of data chunks stored in the second memory system are substantially the same
remove the indication in the management table associated with the first memory system that one or more updated data chunks stored in the first memory system are a more recent version of the data chunks than the counterpart one or more data chunks stored in the second memory system; and
remove the indication in the management table associated with the second memory that one or more updated data chunks stored in the second memory system are a more recent version of the data chunks than the counterpart one or more data chunks stored in the first memory system.

19. The host system of claim 11, wherein the first memory system is an embedded flash memory.

20. The host system of claim 19, wherein the second memory system is a removable memory card.
